(19) United States
(12) Patent Application Publication
(10) Pub. No.: US 2020/0227707 A1
(43) Pub. Date: Jul. 16, 2020

(54) Electrical Energy Storage Cell with an Insulating Sleeve

(71) Applicant: Bayerische Motoren Werke Aktiengesellschaft, Muenchen (DE)

(72) Inventors: Tuncay IDIKURT, Muenchen (DE); Andreas OBERMAIER, Muenchen (DE)

(21) Appl. No.: 16/834,288

(22) Filed: Mar. 30, 2020

Related U.S. Application Data
(63) Continuation of application No. PCT/EP2018/074860, filed on Sep. 14, 2018.

(30) Foreign Application Priority Data
Nov. 13, 2017 (DE) 10 2017 220 133.9

(51) Int. Cl. H01M 2/10; H01M 2/20; H01M 10/6554; B60L 50/64

(52) U.S. Cl. CPC H01M 2/1094; H01M 2/1077; H01M 2220/20; H01M 10/6554; B60L 50/64; H01M 2/206

(57) ABSTRACT

An electrical energy storage device for a motor vehicle, in particular for supplying an electrical drive unit of the motor vehicle, includes a plurality of energy storage cells which are lined up and abut one another and which each have a housing having electrical poles by which the energy storage cells are electrically connected to one another. At least one of the energy storage cells has a sleeve which surrounds the housing of the one energy storage cell in such a way that the housings are electrically insulated from one another.

### CROSS REFERENCE TO RELATED APPLICATIONS

This application is a continuation of PCT International Application No. PCT/EP2018/074860, filed Sep. 14, 2018, which claims priority under 35 U.S.C. § 119 from German Patent Application No. 10 2017 220 133.9, filed Nov. 13, 2017, the entire disclosures of which are herein expressly incorporated by reference.

### BACKGROUND AND SUMMARY OF THE INVENTION

The present invention relates to an electrical energy store for a motor vehicle, in particular for supplying an electrical drive unit of the motor vehicle.

An electrical energy store for a motor vehicle, which supplies, in particular, an electrical drive unit, is known from the prior art.

This electrical energy store comprises an energy storage module which is constructed from a plurality of prismatic energy storage cells which are connected to one another. Each of the energy storage cells comprises two electrical poles and a housing which has, for example in the case of a lithium ion rechargeable battery, a separator, a positive electrode and a negative electrode in the interior. The housing of the energy storage cell protects and surrounds the separator and the two electrodes, wherein these elements are in an ionically conductive electrolyte.

The energy storage cells are arranged in a parallel manner beside one another in a direction of the energy store. As a result, the individual housings of the energy storage cells each touch on their adjacent side surfaces. These contact surfaces between the individual adjacent housings are electrically insulated via adhesive films made of plastic. The insulation ensures that a short circuit generally does not occur and that a voltage flashover does not occur in the event of a fault between the adjacent housings.

The energy storage cells are additionally arranged on a base plate. The base plate acts as a cooling plate in order to ensure that the heat produced by the operation of the energy storage cells is transported away. There is likewise insulation between the energy storage cells and this base plate. This insulation is constructed from a filling compound, a film and a heat conduction plate.

The energy storage module is ultimately also surrounded by two side frames and two end sections. The side frames and the end sections are likewise electrically insulated from the energy storage cells by means of adhesive films.

The energy storage apparatus known from the prior art ensures the implementation of the electrical insulation, but requires an increased amount of installation effort. The adhesive film which is used for the insulation between the individual housings of the energy storage cells requires complicated positioning during its installation. This likewise applies to the insulation between the housings of the energy storage cells and the side frames and/or the end sections.

In addition, the insulation which is situated between the energy storage cells and the base plate has a layer structure having many different materials. On the one hand, this results in increased complexity of the energy storage apparatus. On the other hand, the transport of the heat produced by the energy storage cells suffers.

Therefore, the invention is based on the object of providing an electrical energy storage apparatus which allows simpler installation and implementation of the electrical insulation.

An electrical energy store according to the invention is provided for a motor vehicle, in particular for supplying an electrical drive unit of the motor vehicle, wherein the electrical energy store according to the invention comprises: a plurality of energy storage cells which are lined up and abut one another and each comprise a housing having electrical poles, via which the energy storage cells are electrically connected to one another, wherein at least one of the energy storage cells has a sleeve (cover) which surrounds the housing of the one energy storage cell in such a manner that the housings are electrically insulated from one another.

The energy storage cells each have at least two electrical poles, a positive pole and a negative pole. When used properly, the energy store according to the invention is connected to the electrical drive unit of the motor vehicle via two main connections. For example, 400 V, 500 V, 600 V, 700 V, 800 V, 900 V or 1000 V are present between the two main connections.

The connection of the energy storage cells may be, for example, combinations of series circuits and parallel circuits. In a first combination, at least two energy storage cells can be interconnected to form a parallel circuit and at least two parallel circuits of this type can then be connected in series, for example.

An alternative combination can be constructed from at least two parallel strings each having at least two energy storage cells connected in series.

As explained, each energy storage cell comprises a housing. This housing can be formed from a metal material and/or a non-metal material. In addition, the housing may have a prismatic shape or a cylindrical shape or a pouch-cell shape.

The energy storage cells can preferably be charged again after discharge.

The electrochemical elements of the respective energy storage cell are accommodated in the housing of each of the energy storage cells. These include a positive electrode, a negative electrode and a separator, which are situated together in an electrolyte solution.

The energy store according to the invention can be installed in a simpler manner as a result of the insulating sleeve according to the invention, in particular as a result of the electrical insulation ensured thereby. This is because the housing can be surrounded with the sleeve before arranging and connecting the energy storage cells and no individual films have to be positioned in a complicated manner. This saves manufacturing and installation costs.

The sleeve of the energy store according to the invention is preferably in the form of shrink tubing and is formed, in particular, from a plastic and/or from polytetrafluoroethylene.

Depending on the desired electrical breakdown strength, the shrink tubing can be formed from a number of different materials and can be thin-walled, medium-walled or thick-walled based on its wall thickness. The electrical breakdown strength provides information relating to how high the electrical field strength in a material can be at most without resulting in an arc or spark. Depending on the required standard and the electrical characteristic variables of the energy store, the shrink tubing acting as the insulating sleeve has a particular electrical breakdown strength.

The sleeve of the energy store according to the invention can alternatively be formed from plastic, in particular from an injection-molded plastic.

The sleeve may be formed, for example, by encasing the housing of the energy storage cell with the plastic in an injection-molding method. Depending on the requirements, the sleeve can be manufactured in different wall thicknesses in different sections of the housing.

The sleeve of the energy store according to the invention can alternatively preferably be formed from an elastic plastic, in particular from an elastomer.

Depending on the requirements, the sleeve can be manufactured in different wall thicknesses in different sections of the housing.

The different variants of the sleeve explained above can be designed in such a manner that they encase or cover the housing at least in the sections in which the insulation is necessary and desired.

Alternatively, the energy store according to the invention can be configured in such a manner that the housing of the at least one energy storage cell, with the exception of the electrical poles, is completely surrounded by the sleeve.

Furthermore, the energy store according to the invention can be configured in such a manner that, of the plurality of energy storage cells, (only) every second energy storage cell has the sleeve.

Depending on the electrical requirements imposed on the energy store according to the invention, it may be sufficient to provide only the housing of every second energy storage cell with the sleeve. The energy storage cells which are lined up are reliably insulated from one another as a result and the installation and/or manufacturing effort is reduced because not every energy storage cell has to be equipped with the sleeve.

Alternatively, the electrical energy store can be configured in such a manner that each of the energy storage cells each has the sleeve.

In addition, the energy store according to the invention can be configured in such a manner that the sleeves of the energy storage cells are identical, in particular are formed from an identical material.

Furthermore, the energy store according to the invention can be configured in such a manner that the sleeves of the energy storage cells have a different structure. For example, at least one of the sleeves can be formed from the elastomer and others can be formed from the injection-molded plastic. Alternatively, at least one of the sleeves can be formed from the elastomer and others can be formed from the shrink tubing. Furthermore, alternatively, at least one of the sleeves can be formed from the injection-molded plastic and others can be formed from the shrink tubing.

In addition, the energy store according to the invention can be configured in such a manner that the energy store contains an energy storage module comprising the plurality of energy storage cells which are lined up and abut one another, wherein each of the energy storage cells has the sleeve, and the sleeves also have an electrically insulating effect with respect to a base plate of the energy storage module, wherein the base plate is arranged below the energy storage cells on a side of the energy storage cells facing away from the electrical poles.

Since the sleeves each surround the energy storage cells in such a manner that they also have an insulating effect on the underside of the energy storage cells, effective insulation with respect to the base plate is ensured.

The base plate may be part of a cooling apparatus. The sleeve according to the invention makes it possible to dispense with plastic films and heat conduction plates installed between energy storage cells and the base plate in the prior art.

This configuration of the energy store according to the invention consequently results in a further reduction in the manufacturing and installation effort.

Moreover, the energy store according to the invention can be configured in such a manner that the energy store contains an energy storage module comprising the plurality of energy storage cells which are lined up and abut one another, wherein each of the energy storage cells has the sleeve, and the sleeves have an electrically insulating effect with respect to at least one side frame of the energy storage module having side struts, wherein at least one of the side struts of the side frame is arranged to the side of the energy storage cells lined up in a longitudinal direction of the energy storage module.

In this configuration according to the invention of the energy store, the energy storage module can additionally have at least the side frame. The side struts of the side frame may be on one or both sides of the energy storage module and can fix the individual energy storage cells in their position. The sleeves undertake the electrical insulation of the energy storage cells with respect to the side frame.

The side struts may be part of the base plate mentioned above or the base plate and the side struts may be integrated in one another.

Furthermore, the electrical energy store can be implemented in such a manner that the energy store contains an energy storage module comprising the plurality of energy storage cells which are lined up and abut one another, wherein each of the energy storage cells has the sleeve, and the sleeves have an electrically insulating effect with respect to at least two end sections of the energy storage module, wherein at least one of the end sections is arranged at one end and another of the end sections is arranged at an opposite end of the energy storage module.

The energy storage module can here have at least two end sections which terminate the energy storage module at its ends. At least one of the end sections may be formed from a metal or non-metal material. In the present energy store according to the invention, the insulation with respect to the end sections is achieved by means of the sleeve.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic illustration of an energy storage cell of an energy store according to an embodiment of the invention, wherein the energy storage cell has a housing.

FIG. 2 is a schematic illustration of an energy store according to an embodiment of the invention.

### DETAILED DESCRIPTION OF THE DRAWINGS

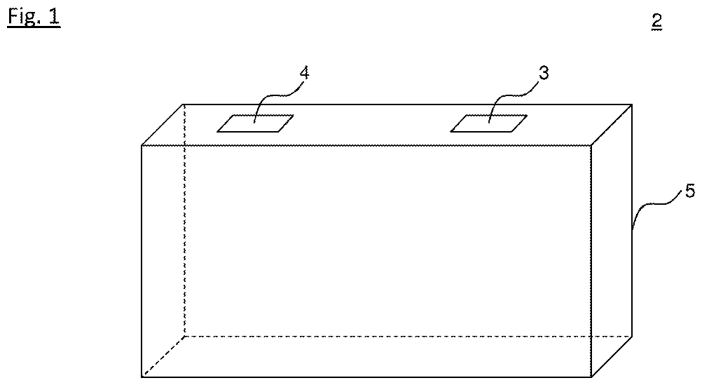

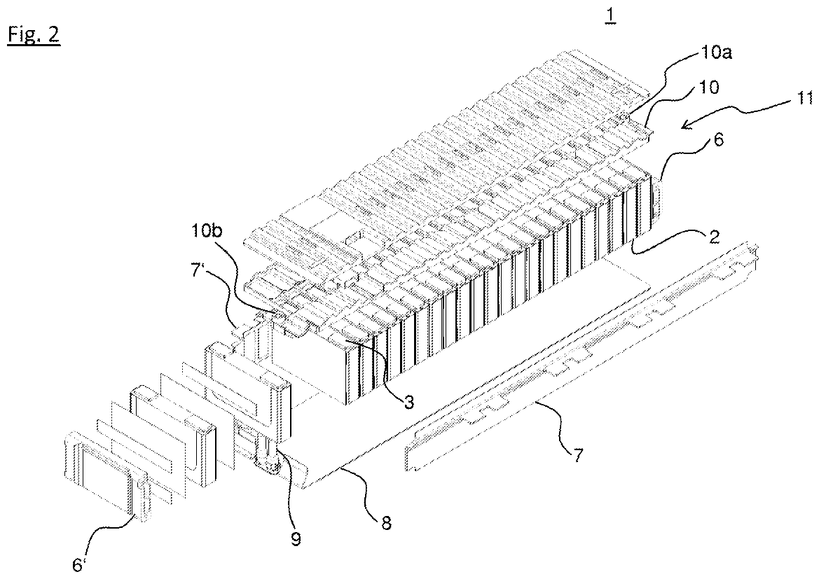

FIG. 1 shows a schematic illustration of an energy storage cell 2 of an energy store 1 according to the invention illustrated in FIG. 2.

The energy storage cell 2 has a preferably prismatic housing 5, on which two electrical poles, a first pole 3 and a second pole 4, are arranged. The poles 3, 4 are a negative pole and a positive pole of the energy storage cell 2, via which electrical contact can be made with the energy storage cell 2. The two electrical poles 3, 4 are arranged on a top side of the energy storage cell 2. In this respect, the energy storage cell 2 can also be designed differently; in particular, the poles 3, 4 can also be arranged at other locations, for example the side surfaces.

A sleeve which is not illustrated in FIG. 1 preferably completely surrounds the housing 5, apart from the two electrical poles 3, 4. The sleeve of the energy storage cell 2 is an important element of the energy store 1 according to the invention.

FIG. 2 shows a view of the energy store 1. When used as intended, the energy store 1 supplies an electrical drive unit of a motor vehicle.

The energy store 1 contains at least one single energy storage module 11 which has a plurality of the energy storage cells 2 explained with reference to FIG. 1.

The energy storage cells 2 are lined up in a longitudinal direction of the energy storage module 11 and are arranged on a base plate 8. The energy storage cells 2 touch on their surfaces pointing in the longitudinal direction.

The energy storage module 11 contains two end sections 6, 6′ which abut the respective last energy storage cells 2 in the longitudinal direction of the energy storage module 11.

A side frame of the energy storage module 11 runs to the side of the energy storage cells 2. The side frame has at least two side struts 7, 7′ which each run on one of the sides of the energy storage cells 2 in the longitudinal direction and likewise abut the energy storage cells 2. The side struts 7, 7′ are fastened to the end sections 6, 6′. Overall, the side struts 7, 7′, together with the end sections 6, 6′, completely encircle the plurality of energy storage cells 2 and keep them in their compact, lined-up arrangement.

The electrical poles (negative and positive poles) of the energy storage cells 2 are on a side of the energy storage cells 2 facing away from the base plate 8.

A contact-making plate 10 makes contact with the individual energy storage cells 2. The energy storage cells 2 are preferably connected to one another via the contact-making plate 10 in such a manner that a plurality of strings of the energy store 1 are connected in parallel with one another, wherein each of the strings is constructed from a series circuit comprising a plurality of the energy storage cells 2. At each of its ends in the longitudinal direction, the contact-making plate 10 has a main connection 10a, 10b, via which the energy store 1 can be connected to the electrical drive unit.

The energy storage cells 2 are electrically insulated from one another and from the base plate 8, the side struts 7, 7′ and the end sections 6, 6′ in order to comply with legal standards. The sleeve mentioned with respect to FIG. 1 undertakes this insulation. Each of the energy storage cells 2 preferably contains a respective sleeve which surrounds the corresponding housing 5 and ensures the insulation mentioned. The sleeve is preferably configured in such a manner that it covers at least those regions of the housing 5 in which insulation is required.

If, for example, the end sections 6, 6′ and/or the side struts 7, 7′ and/or the base plate 8 is/are formed from an insulating plastic, it is only necessary to provide every second of the energy storage cells 2 with an insulating sleeve.

If, in contrast, the end sections 6, 6′ and/or the side struts 7, 7′ and/or the base plate 8 is/are constructed from a conductive metal, each of the energy storage cells 2 is equipped with an insulating sleeve which very particularly preferably completely encases the respective energy storage cell 2.

A filling compound known from the prior art can be present between the base plate 8 and the undersides of the energy storage cells 2. This filling compound ensures tolerance compensation. If the energy storage cells 2 are equipped with the sleeves which have been explained, it is not necessary to provide additional insulating films or an additional heat plate between the base plate 8 and the energy storage cells 2.

FIG. 2 also shows an optional cooling apparatus. This cooling apparatus contains lines 9 which run through the energy store 1 and can be used to conduct a cooling medium through the energy store 1 in order to cool the energy storage cells.

According to the invention, the sleeves surrounding the energy storage cells 2 can be implemented in a variety of ways.

For example, the sleeves can be implemented by way of shrink tubing. Before inserting the energy storage cells into the energy store 1 according to the invention, each of the energy storage cells to be insulated is inserted into shrink tubing of corresponding dimensions and is then subjected to a heat treatment. As a result, the shrink tubing shrinks and attaches to the housing 5 of the respective energy storage cell 2. The shrink tubing is preferably formed from a material which, after the heat treatment, can be used at normal operating temperatures of the energy store 1. If the cooling apparatus explained is provided, the operating temperature can be kept in a range permissible for the material of the shrink tubing. A complete sleeve for the housing 5, apart from the electrical poles 2, 3, can be implemented by way of the shrink tubing by means of appropriate cutting or by means of folding techniques.

Alternatively, the sleeve can also be implemented by way of a plastic surrounding the housing 5. Such a sleeve is preferably injection-molded by inserting the respective energy storage cell 2 into a mold and injecting a plastic into an intermediate space present between the housing 5 and the mold. After the plastic has cured, the energy storage cell can be removed from the mold again.

Furthermore, alternatively, the sleeve can be formed from an elastic plastic, for example from an elastomer.

If a plurality of the energy storage cells 2 of the energy store 1 have the insulating sleeve, they can have either an identical structure according to one of the alternatives above or can accordingly have a different structure.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An electrical energy store for a motor vehicle, comprising:
a plurality of energy storage cells which are lined up and abut one another and each comprise a housing having electrical poles, via which the energy storage cells are electrically connected to one another,
wherein at least one of the energy storage cells has a sleeve which surrounds the housing of the one energy storage cell such that the housings are electrically insulated from one another.

2. The energy store according to claim 1, wherein
the sleeve is in the form of shrink tubing and is formed from a plastic and/or from polytetrafluoroethylene.

3. The energy store according to claim 1, wherein
the sleeve is formed from plastic.

4. The energy store according to claim 3, wherein
the plastic is an injection-molded plastic.

5. The energy store according to claim 1, wherein
the sleeve is formed from an elastic plastic.

6. The energy store according to claim 5, wherein
the elastic plastic is an elastomer.

7. The energy store according to claim 1, wherein
the housing of the at least one energy storage cell, with an exception of the electrical poles, is completely surrounded by the sleeve.

8. The energy store according to claim 1, wherein
of the plurality of energy storage cells, every second energy storage cell has the sleeve.

9. The energy store according to claim 1, wherein
the plurality of energy storage cells each have the sleeve.

10. The energy store according to claim 1, wherein
the sleeves of the energy storage cells are identical.

11. The energy store according to claim 1, wherein the sleeves of the energy storage cells have a different structure, wherein either:
the sleeves are formed from the elastomer and the injection-molded plastic,
the sleeves are formed from the elastomer and the shrink tubing,
the sleeves are formed from the injection-molded plastic and the shrink tubing, or
the sleeves are formed from a combination of the elastomer, the injection-molded plastic and the shrink tubing.

12. The energy store according to claim 1, wherein
the energy store contains an energy storage module comprising the plurality of energy storage cells which are lined up and abut one another, wherein each of the energy storage cells has the sleeve,
and the sleeves have an electrically insulating effect with respect to a base plate, wherein the base plate is arranged on a side of the energy storage cells facing away from the electrical poles.

13. The energy store according to claim 1, wherein
the energy store contains an energy storage module comprising the plurality of energy storage cells which are lined up and abut one another, wherein each of the energy storage cells has the sleeve,
and the sleeves have an electrically insulating effect with respect to at least one side frame having side struts, wherein at least one of the side struts is arranged to the side of the energy storage cells lined up in a longitudinal direction of the energy storage module.

14. The energy store according to claim 1, wherein
the energy store contains an energy storage module comprising the plurality of energy storage cells which are lined up and abut one another, wherein each of the energy storage cells has the sleeve,
and at least the sleeves have an electrically insulating effect with respect to at least two end sections, wherein at least one of the end sections is arranged at one end and another of the end sections is arranged at an opposite end of the energy storage cells lined up in the longitudinal direction of the energy storage module.

15. The energy store according to claim 1, wherein
the energy store is configured to supply energy to an electrical drive unit of the motor vehicle.
